(19) United States
(12) Patent Application Publication
(10) Pub. No.: US 2007/0262261 A1
(43) Pub. Date: Nov. 15, 2007

(54) Isolating Plates and Imaging Array of Crystal Lattices and the Method of Making the Same

(75) Inventor: Hsin-Chin Liang, Taoyuan County (TW)

Correspondence Address: WPAT, PC;INTELLECTUAL PROPERTY ATTORNEYS, 2030 MAIN STREET, SUITE 1300, IRVINE, CA, 92614, US

(73) Assignee: INSTITUTE OF NUCLEAR ENERGY RESEARCH ATOMIC ENERGY, Taoyuan County (TW)

(21) Appl. No.: 11/457,441

(22) Filed: Jul. 13, 2006

(30) Foreign Application Priority Data
May 9, 2006 (TW) 095116351

(51) Int. Cl. G01T 1/20

(52) U.S. Cl. 250/368; 250/362

(57) ABSTRACT

A method for making isolating plates for imaging array of crystal lattices, which comprises steps of: providing a substrate; coating a mirror film on the substrate by evaporation so as to form a mirror substrate; and, forming a comb-like isolating plate by the formation of a plurality of notches on the mirror substrate. By assembling a plurality of the comb-like isolating plates to form an array with a plurality of isolated spaces. After inserting a scintillator segment in each of those isolated spaces, an imaging array of crystal lattices for gamma ray detection in nuclear medicine can be manufactured. The imaging device of the invention is preferred since it is easy to assemble, inexpensive, and exhibits desirable imaging and light condensing effects.

### FIELD OF THE INVENTION

The present invention relates to an imaging probe for nuclear medicine medical imaging device and the manufacturing method thereof, and more particularly, to an crystal array capable of forming images basing on the radiation energies detected thereby, and the isolating plate structure suitable to be applied in the crystal array.

### BACKGROUND OF THE INVENTION

Gamma imaging probe is the key component for nuclear medicine medical imaging devices, which is used for converting gamma rays into electrical signals while using the same for location positioning. Almost every available gamma imaging probe is manufactured basing on a scintillation radiation detector, that it is basically a scintillator block coupled to a photomultiplier tube as the scintillator block is used for detecting the gamma rays emitted from radioactive substances while converting the same into corresponding visible light to be guided to the photomultiplier tube through the light-guide surface thereof, and the photomultiplier tube is used for receiving the visible light while converting the same into electrical signal and thus amplifying the electrical signals. Recently, for enhancing resolution to be adapted for the requirements of research/animal medicine and small clinical nuclear imaging devices, the scintillation radiation detector using a whole scintillator block is replaced by an improved radiation detector of scintillation crystal array composed of a plurality of scintillator segments. As the detection of each scintillator segment represents a pixel of an image formed by the scintillation crystal array, it is essential that each scintillator segment is optical isolated form each other, that is, the scintillation light of each scintillator segment must be restricted therein so as to be guided through its light-guide surface into the corresponding photomultiplier tube. Therefore, every surface of each scintillator segment must be processed by a light-isolation process, so that the scintillation light can be reflect or diffuse back to the corresponding scintillator segment as it reaches the surface of the same, and thus the scintillation light is restricted in its corresponding scintillator segments.

Generally, the surface of each scintillator segment is treated either by coating a layer of white pigment or by warping a thin layer of Teflon film thereon. Furthermore, most scintillation crystal array manufactures use a mixture of epoxy and white power of metal oxide, such as MgO, TiO2, etc., to fill the gaps in the crystal array, as the radiation detector disclosed in U.S. Pat. No. 5,227,634, entitled “Radiation Detector for Computer Tomography”. However, the light-collecting ability of the aforesaid radiation detector is not preferred.

Recently, there are plenty of researches focused on using a plurality of mirror films to be processed for assembling the same into an array of lattices. That is, each mirror film available is processed into a comb-like isolating plate by a laser cutting process, and thus the plural comb-like isolating plates are assemble into an array of lattices while enabling each grid to receive an individual scintillator segment in respective so as to accomplish a scintillation crystal array. The advantage of the aforesaid method is that, as soon as the assembly of the scintillation crystal array is accomplished, the required surface treatment of optical isolation is also achieved. One such research uses VM 2000 of 3M company for making the scintillation crystal array.

Although the forgoing method of making a scintillation crystal array by the assembly of a plurality of comb-like mirror films is preferred, it is difficult to implement. The first difficulty encountered is the selection of material used for making the mirror film. Since the scintillation crystal array is arranged directly against the photomultiplier tube that it is separated form the strong gradient electric field inside the photomultiplier tube by only a thin layer of glass, the mirror film must be made of plastic substrate, not metal substrate. It is because that the strong gradient electric field will cause an array composed of metal mirror film to accumulate static therein, and thus the electric field of the accumulated static will have adverse affect on the electric field gradient of the photomultiplier tube that it will eventually weaken the signal amplifying ability of the photomultiplier tube. From the above description, it is noted that only the VM series products of 3M company are currently available and suitable to be used as the mirror film. Within the VM series, only the reflection wavelength of VM 2000 matches with that of the scintillation light of the scintillation segments arranged in the grids of the scintillation crystal array. As the reflection wavelengths of the more recent VM 2002 and VM 2003 are biased toward longer wavelength, i.e. from green light to near infrared light, while scintillation light of the scintillation segments are primarily composed of light ranged from blue light to near ultra-violet. However, not only the VM 2000 is pricey, but also it is no longer in production and thus it is difficult to acquire. Another difficulty relating to the process is laser cutting. As the mirror film is made of thin plastic substrate with thickness between 2.4 mil-2.7 mil, i.e. less than 0.06 mm, it is easy to be cut through even by low-power laser. Therefore, the width of the notches formed by laser cutting can be no thinner than 0.1 mm, which is still too wide with respect to the thickness of the VM 2000. That is, during the assembly of the crystal array by clipping the notches of the comb-like isolating plates to each other, the comb-like isolating plates can not fixedly clip to each other and thus the assembled crystal array is prone to fall apart since the larger-than-0.1 mm notch can not grip fixedly onto the 0.06 mm substrate. Therefore, it is difficult to accomplish the assembly since any newly configured comb-like isolating plate can fall of at any time during the assembly. Moreover, even when an assembly is accomplished and each grid thereof is enabled to receive an individual scintillator segment, the resulting scintillation crystal array is still a loose structure that a further process is required for holding the loose structure into a rigid block.

Therefore, it is in need of an improved isolating plate and imaging array manufactured thereby and the method for manufacturing the same that are free from the abovementioned shortcomings.

### SUMMARY OF THE INVENTION

The primary object of the present invention is to provide an inexpensive method for manufacturing comb-like isolating plates, being adapted to be easily assembled into an array of lattices, by means of evaporation and laser cutting.

It is another object of the invention to provide an isolating plate and the imaging array manufactured thereby as well as the manufacturing methods of the two. The imaging array is accomplished by enabling each lattice of an array, which is configured of a plurality of such isolating plates, to receive an individual scintillator segment. Thus the light-collecting ability of the imaging array is enhanced while enabling the same to create comparatively clear images.

To achieve the above objects, the present invention provides a method for manufacturing an isolating plate for imaging array, which comprises steps of: providing a substrate with a specific thickness; coating a mirror film on the substrate by a means of evaporation so as to form a mirror substrate; and forming a comb-like isolating plate by the formation of a plurality of notches on the mirror substrate; wherein, the width of each notch is equal to the thickness of the substrate.

Preferably, the substrate is made of a plastic material. Moreover, the plastic material can be a material selected form the group consisting of polyvinyl chloride (PVC), polyethelyne (PE), and a polyester film.

Preferably, the means of evaporation is a low-temperature plasma evaporation process.

Preferably, the notch is formed by means of laser cutting.

Preferably, the mirror film can be made of a material selected form the group consisting of a metal material and a polymer material.

In addition, to achieve the above objects, the present invention provides a method for manufacturing an imaging array, which comprises the steps of: providing a substrate with a specific thickness; coating a mirror film on the substrate by means of evaporation so as to form a mirror substrate; forming a comb-like isolating plate by the formation of a plurality of notches on the mirror substrate, while enabling the width of each notch to be equal to the thickness of the substrate; providing while assembling a plurality of the comb-like isolating plates to form an array with a plurality of isolated lattices; and inserting a scintillator segment into each of those isolated lattices so as to complete the manufacturing of an imaging array.

Preferably, the method for manufacturing an imaging array further comprises a step of: wrapping the periphery of the imaging array by a thin film for solidifying the whole structure of the imaging array. Moreover, the thin film can be made of a self-adhesive, opaque material, such as a self-adhesive aluminum foil.

Furthermore, to achieve the above objects, the present invention provides an imaging array, comprising: an array, composed of a plurality of lattices, each lattice being isolated from one another; and a plurality of scintillator segments, each being received in the isolated lattices of the array in respective; wherein, the array is configured of a plurality of comb-like isolating plates, each being coated with a layer of mirror film and having a plurality of notches formed thereon while enabling the width of each notch to match to the thickness of the comb-like isolating plate itself. This leads clipping the notches of the comb-like isolating plates to each other.

Other aspects and advantages of the present invention will become apparent from the following detailed description, taking in conjunction with the accompanying drawings, illustrating by way of example the principles of the present invention.

### BRIEF DESCRIPTION OF THE DRAWINGS

FIG. 1 is a flow chart depicting a method for manufacturing an isolating plate for imaging array according to a preferred embodiment of the invention.

FIG. 2 is a flow chart depicting a method for manufacturing an imaging array according to a preferred embodiment of the invention.

FIG. 3A is a perspective view of an isolating plate for imaging array according to the present invention.

FIG. 3B is an A-A′ sectional view of the isolating plate of FIG. 3A.

FIG. 4A is a perspective view of an array of lattices according to the present invention.

FIG. 4B is a perspective view of an imaging array according to the present invention.

FIG. 5 shows a performance comparison between an imaging array of the invention with other imaging arrays.

### DESCRIPTION OF THE PREFERRED EMBODIMENT

For your esteemed members of reviewing committee to further understand and recognize the fulfilled functions and structural characteristics of the invention, several preferable embodiments cooperating with detailed description are presented as the follows.

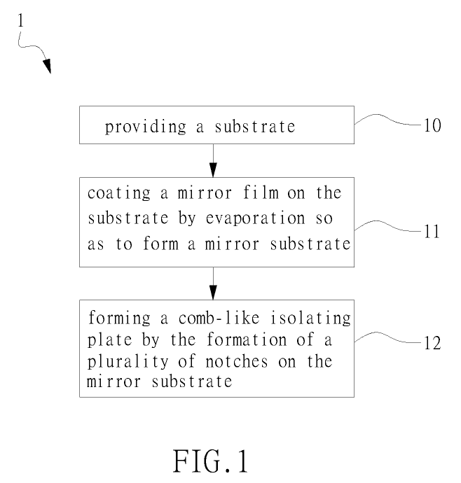

Please refer to FIG. 1, which is a flow chart depicting a method for manufacturing an isolating plate for imaging array according to a preferred embodiment of the invention. The method of FIG. 1 starts at step 10. At step 10, a substrate is provided, whereas the substrate can be a plastic substrate made of a plastic material, such as polyvinyl chloride (PVC), polyethelyne (PE), or a polyester film, etc., but is not limited thereby; and then the flow proceeds to step 11. At step 11, a mirror film is coated on the two surface of the substrate so as to form a mirror substrate with light reflecting ability, and then the flow proceeds to step 12. In a preferred aspect, the coating of the mirror film is processed by a means of evaporation, such as a low-temperature plasma evaporation, whereas the mirror film can be made of a metal material, such as aluminum, silver, etc, or polymer material, but is not limited thereby. At step 12, a comb-like isolating plate is manufactured by forming a plurality of notches on the mirror substrate by a means of laser cutting, while enabling the width of each notch to be equal to the thickness of the substrate.

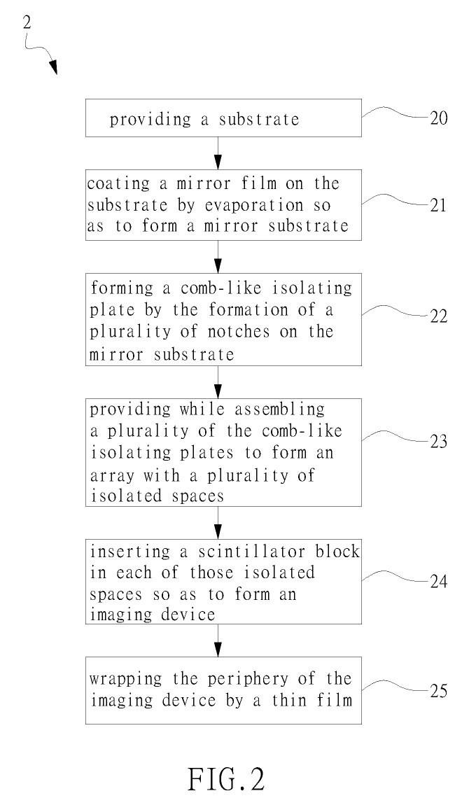

Utilizing the abovementioned comb-like isolating plate, an imaging array can be manufactured that the flow chart depicting a method for manufacturing an imaging array is shown in FIG. 2. The flow starts at step 20. At step 20, a substrate is provided, and then the flow proceeds to step 21. At step 21, a mirror film is coated on the two surface of the substrate so as to form a mirror substrate with light reflecting ability, and then the flow proceeds to step 22. At step 22, a comb-like isolating plate is manufactured by forming a plurality of notches on the mirror substrate by a means of laser cutting, and then the flow proceeds to step 23. It is noted that the characteristics of step 20, 21, 22 are the same as those of step 10, 11, 12 shown in FIG. 1, and thus are not described further herein.

At step 23, a plurality of such comb-like isolating plates are provided and assembled to form an array with a plurality of isolated lattices, whereas the assembly is performed by aligning the notches of any two such comb-like isolating plates to face toward each other and then inserting one comb-like isolating plate into the notches of another comb-like isolating plate and vice versa, and then the flow proceeds to step 24. At step 24, in each lattice of the so-assembled array, a scintillator segment is inserted therein so as to complete the manufacturing of an imaging array, and then the flow proceeds to step 25. At step 25, a thin film is provided for wrapping the periphery of the imaging array thereby, whereas the thin film can be made of a self-adhesive, opaque material, such as a self-adhesive aluminum foil.

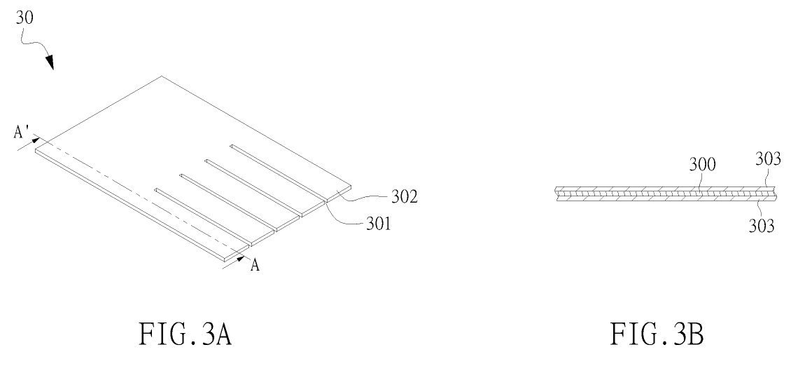

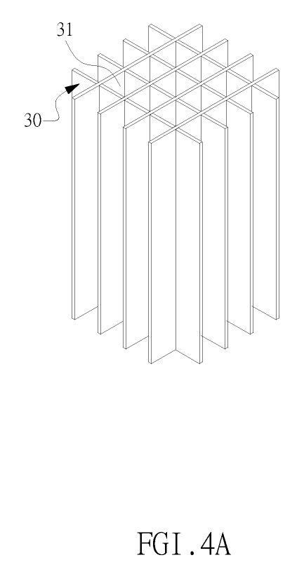

Please refer to FIG. 3A and FIG. 3B, which are perspective view of an isolating plate for imaging array and the A-A′ sectional view thereof, respectively. As a 5×5 array is used as an illustration and shown in the embodiment of FIG. 3A, the comb-like isolating plate 30 is substantially a substrate comprised of five comb teeth 302 and four notches 301. The substrate 300 can be made of a plastic material, such as polyvinyl chloride (PVC), polyethelyne (PE), or a polyester film, etc., while the top and bottom surfaces of the substrate 300 are coated with a mirror film 303 with light reflecting ability. It is noted that the mirror film 303 can be made of metal material or polymer materials, whereas the metal material can be aluminum or silver, etc, but is not limited thereby.

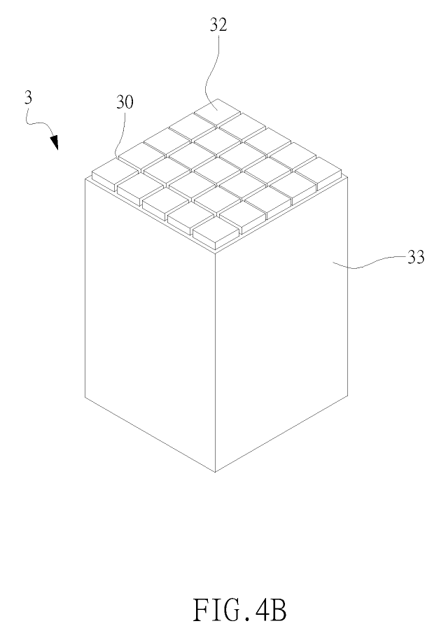

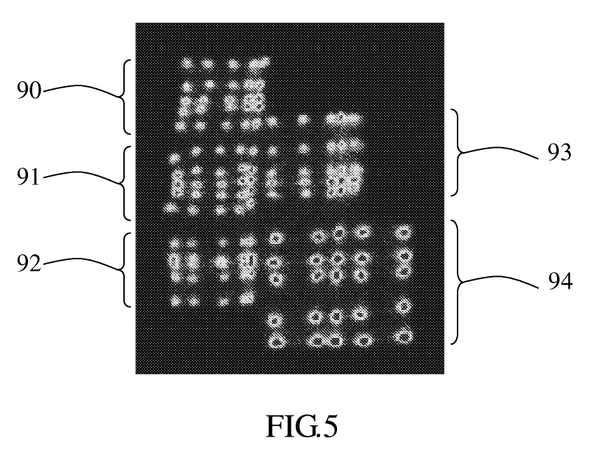

Please refer to FIG. 4, which is a perspective view of an array of lattices according to the present invention. In FIG. 4, a plurality of such comb-like isolating plates 30 are provided and assembled to form a 5×5 array with a plurality of isolated lattices 31, whereas the assembly is performed by aligning the notches of any two such comb-like isolating plates 30 to face toward each other and then inserting one comb-like isolating plate into the notches of another comb-like isolating plate and vice versa. Please refer to FIG. 4B, which is a perspective view of an imaging array according to the present invention. In FIG. 4B, in each lattice 31 of the so-assembled 5×5 array, a scintillator segment 32 is inserted therein so as to complete the manufacturing of an imaging array 3. In addition, a thin film 33 is provided for wrapping the periphery of the imaging array thereby for solidifying the whole structure of the imaging array 3, whereas the thin film 33 can be made of a self-adhesive, opaque material, such as a self-adhesive aluminum foil.

Please refer to FIG. 5, which shows a performance comparison between an imaging array of the invention with other imaging arrays. The performance comparison is performed by placing the 5×5 imaging array of the invention, a 5×5 imaging array made of VM 2000 and a 5×5 imaging array manufactured by a conventional wrapping method in the center area of a photomultiplier simultaneously. In FIG. 5, as each dot represents a scintillator segment and thus each 5×5 imaging array is represented by a block of 25 dots, it is considered that the performance of an imaging array is good when all 25 dots of that imaging array are clearly identifiable and distinct from each other. In FIG. 5, the three imaging arrays 90, 91, 92 are all composed of 25 1 mm×1 mm scintillator segments, which are respectively a 5×5 imaging array of the invention, an 5×5 imaging array made of VM 2000 and a 5×5 imaging array manufactured by a conventional wrapping method. Moreover, the two imaging arrays 93, 94 are all manufactured by a conventional wrapping method, whereas the imaging array 93 is composed of 25 1.2 mm×1.2 mm scintillator segments and the imaging array is composed of 25 1.8 mm×1.8 mm scintillator segments. It is noted that the smaller the scintillation segments are, the better the resolution a probe can provide. As shown in FIG. 5, the dots of the conventional imaging array 94 of 1.8 mm×1.8 mm scintillator segments are clearly identifiable and distinct from each other, but the dots of the conventional imaging array 93 of 1.2 mm×1.2 mm scintillator segments can only be barely identifiable and distinct from each other. As for those imaging arrays composed of 1 mm×1 mm scintillator segments, only the dots of the one made of VM 2000 and the imaging array of the invention can be clearly identifiable and distinct from each other. The aforesaid performance differences are directly resulting from the superiority of the light-collecting ability of the five imaging arrays 90-94. The better the light-collecting ability of an imaging array is, the higher the signal to noise ratio (SNR) will be and thus the better the resolution can be. Hence, it is concluded that the performance of the imaging array of the invention is equal to that of the imaging array made of VM 2000, but under the condition that the imaging array of the present invention is not only cheaper, but also is comparatively easier to assemble.

To sum up, the imaging array of the invention is preferred by its inexpensive manufacturing cost, good light-collecting ability and uncomplicated assembly process.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

What is claimed:

1. A method for manufacturing an isolating plate for imaging array, comprising steps of:
providing a substrate with a specific thickness;
coating a mirror film on the substrate by means of evaporation so as to form a mirror substrate; and
forming a comb-like isolating plate by the formation of a plurality of notches on the mirror substrate;
wherein, the width of each notch is equal to the thickness of the substrate

2. The method of claim 1, wherein the substrate is made of a plastic material.

3. The method of claim 2, wherein the plastic material is a material selected form the group consisting of polyvinyl chloride (PVC), polyethelyne (PE), and a polyester film.

4. The method of claim 1, wherein the means of evaporation is a low-temperature plasma evaporation process.

5. The method of claim 1, wherein the notch is formed by means of laser cutting.

6. The method of claim 1, wherein the mirror film is made of a material selected form the group consisting of a metal material and a polymer material.

7. A method for manufacturing an imaging array, comprising steps of:
providing a substrate with a specific thickness;
coating a mirror film on the substrate by a means of evaporation so as to form a mirror substrate;
forming a comb-like isolating plate by the formation of a plurality of notches on the mirror substrate, while enabling the width of each notch to be equal to the thickness of the substrate;
providing while assembling a plurality of the comb-like isolating plates to form an array with a plurality of isolated lattices; and
inserting a scintillator segment into each of those isolated lattices so as to complete an imaging array.

8. The method of claim 7, wherein the substrate is made of a plastic material.

9. The method of claim 8, wherein the plastic material is a material selected form the group consisting of polyvinyl chloride (PVC), polyethelyne (PE), and a polyester film.

10. The method of claim 7, wherein the means of evaporation is a low-temperature plasma evaporation process.

11. The method of claim 7, wherein the notch is formed by means of laser cutting.

12. The method of claim 7, wherein the mirror film is made of a material selected form the group consisting of a metal material and a polymer material.

13. The method of claim 7, wherein the notches of one of the plural comb-like isolating plates are formed to tightly fit with another comb-like isolating plate.

14. The method of claim 7, further comprising a step of:
wrapping the periphery of the imaging array by a thin film.

15. The method of claim 7, wherein the thin film is made of a self-adhesive, opaque material.

16. An imaging array, comprising:
an array, composed of a plurality of lattices, each lattice being isolated from one another; and
a plurality of scintillator segments, each being received in the isolated lattices of the array in respective;
wherein, the array is configured of a plurality of comb-like isolating plates, each being coated with a layer of mirror film and having a plurality of notches formed thereon while enabling the width of each notch to equal to the thickness of the comb-like isolating plate itself for clipping the notches of the comb-like isolating plates to each other.

17. The imaging array of claim 16, wherein the comb-like isolating plate is made of a plastic material.

18. The imaging array of claim 17, wherein the plastic material is a material selected form the group consisting of polyvinyl chloride (PVC), polyethelyne (PE), and a polyester film.

19. The imaging array of claim 16, wherein the notches of one of the plural comb-like isolating plates are formed to tightly fit with another comb-like isolating plate.

20. The imaging array of claim 16, further comprising:
a thin film, made of a self-adhesive, opaque material, being arranged to wrap around the periphery of the array.
